(19) United States
(12) Patent Application Publication
(10) Pub. No.: US 2003/0061285 A1
(43) Pub. Date: Mar. 27, 2003

(54) Interactive communication system and method using an image

(76) Inventors: Tatsuo Usui, Tokyo (JP); Masaaki Usui, Tokyo (JP)

Correspondence Address: REED SMITH HAZEL & THOMAS LLP, Suite 1400, 3110 Fairview Park Drive, Falls Church, VA, 22042, US

(21) Appl. No.: 09/961,399

(22) Filed: Sep. 25, 2001

(51) Int. Cl. G06F 15/16

(52) U.S. Cl. 709/205; 345/751

(57) ABSTRACT

The present invention is directed to providing an interactive communication system which implements real-time interactive communication using an audio-visual tool. In one embodiment, the system provides an interactive communication system and method that allows interactive communication simultaneously using a real-time moving image and voice over a network. In another embodiment, the system and method allows interactive communication using real-time images and voice between a plurality of users. In a further embodiment, the system and method combines the direct transmission of text data and other information with real-time transmission of the images all the users' and voices.

### BACKGROUND OF THE INVENTION

Explanation of Words:

Before an explanation for the present invention is given, a word “chat” will be briefly described. The work “chat” used in the present invention means the following system capable of making a conversation with the people of all over the world in real time using an IRC server network extended in the world.

The server for using the IRC (Internet Relay Chat) is located at various places of the world including America. IRC servers are mutually linked, and thereby, a wide IRC network is formed. In this case, these servers are not all connected by one large network, but there exists a single server, which is not linked with other servers. A user uses a server connect software called as client, and thereby, the user can make a connection with the IRC server. Further, the user makes a connection with the IRC server, and thereby, it is possible to make a conversation with not only people connecting with the same server, but also people connecting with other servers belonging to the same IRC network. Therefore, it is possible to make connections with many people via the IRC.

1. Field of the Invention

The present invention relates to an interactive communication method using an image, and more particularly, to an interactive communication method, which can make an interactive communication in combination with character chat, live (real time) video image, voice, text character, file, photograph, email or the like, using Internet.

2. Prior Art

Recently, in this kind of communication field using the image, a cellular phone equipped with a small-sized digital camera, made of Japanese juridical person, J-PHONE Co. has been appeared.

The digital camera has 11 ten thousands of pixels, and is not so high image quality. In this case, the digital camera can transmit a taken image to a receiver's cellular phone in a state that the taken image is appended to a long mail. However, in communication means as described above, the image and voice are transmitted separately from each other, and are not simultaneously transmitted. Further, the image is a so-called still image, and a moving image is not sill transmitted at present.

### SUMMARY OF THE INVENTION

Accordingly, an object of the present invention is to provide an interactive communication method, which can make real interactive communication using an audio-visual tool, and can improve relative to information exchange by directly transmitting characters and other information in addition to user's facial expression and voice.

More specifically, an object of the present invention is to provide interactive communication system and method, which can make interactive communication simultaneously using a moving image and voice.

Further, another object of the present invention is to provide interactive communication system and method, which can simultaneously make interactive communication using a moving image and voice with a plurality of persons.

Further, another object of the present invention is to provide interactive communication system and method, which can complexly combine characters, graphics and photographs in addition to the above moving image.

Further, another object of the present invention is to provide interactive communication system and method, which can record the contents of interactive communication, moving images, characters, graphics and photographs, and can always and readily fetch the information.

Further, another object of the present invention is to provide interactive communication system and method, which can simultaneously make interactive communication with a plurality of persons, and further, can call a specific person so as to make interactive communication with only specific person.

Further, another object of the present invention is to provide interactive communication system and method, which can give lessons in various education, various sports, hobbies, recreations and other living environments in the form of interactive communication of substantially one instructor with several students.

In this case, an object of the present invention is to provide an interactive communication system and method using an image such that the instructor oneself is outputted to the instructor's PC (personal computer) using a moving image and/or voice, and likewise, the student oneself is outputted to the student's PC.

The above-mentioned lessons in various education, sports, hobbies, recreations and other living environments are as follows. More specifically, the sports include personal sports such as golf, fencing, tennis, table tennis, group sports such as baseball, soccer, basketball, martial arts such as sumo, wrestling, judo, boxing, sports co-existing with nature, such as surfing, skiing, skating, swimming or the like, and sports having targets, such as fishing, hunting, etc. Therefore, an object of the present invention is to provide interactive communication system and method, which can help student's technical improvement of these sports.

Further, the above-mentioned hobbies and recreations include igo, chess, shogi (Japanese chess), dancing, billiards, piano, gardening, etc. Therefore, an object of the present invention is to provide interactive communication system and method, which can help improvement of student's skill of these hobbies.

Further, the above-mentioned living environments include various medical cares, cosmetic treatment, weight training, flower arrangement (ikebana), the art of flower arrangement, cooking, etc. Therefore, an object of the present invention is to provide interactive communication system and method, which can help improvement of student's skill relative to these living environments.

Further, in the case of sports, instruction means is provided such that student's defects in his form is found out at once so that the students can be earlier understood, and thereby, the students can obtain the skills of sports for a short period. In the case of hobbies and living environments, a portion to be cared is persuaded to the students, and then, the student's skill is improved for a short period. Therefore, an object of the present invention is to provide interactive communication system and method, which can improve student's skill for a short period.

Further, another object of the present invention is to provide interactive communication system and method using an image, which can have the game between users in the same situation, and not the situation of instructor to student, or in the handicapped situation.

Further, another object of the present invention is to provide interactive communication system and method using an image, which can store the content of interactive communication in a receiver tool of student (receiver), and can always fetch the content by the student (receiver) even if the student (receiver) is absent or the content of interactive communication is not received.

Further, another object of the present invention is to provide interactive communication system and method using an image, which have interactive communication means capable of simultaneously making interactive communication with plural persons, and can display a desired person or image on a wide screen.

Further, another object of the present invention is to provide interactive communication system and method using an image, which have means capable of taking and examination from remote place such as obtaining an answer from an examinee for example in the form of interactive communication, and means capable of conducting conference, discussion, lecture at remote place by using other different languages or sign language.

Further, the present invention provides interactive communication system and method using an image, wherein the interactive communication is capable of making transmission and reception using various mobiles such as cellular phone or the like, and a copy is made using a proper device anytime and anywhere, if necessary.

In order to achieve the above objects, the present invention provides interactive communication system and method using an image, including interactive communication means using moving image and voice by a network line.

Further, the present invention provides interactive communication system and method using an image, wherein the interactive communication means is means, which can make simultaneously interactive communication with a plurality of persons.

Further, the present invention provides interactive communication system and method using an image, wherein the interactive communication means includes interactive communication means complexly combining characters, graphics, photographs or the like.

Further, the present invention provides interactive communication system and method using an image, wherein the interactive communication means has a local area network (LAN) which is connected to a network line.

Further, the present invention provides interactive communication system and method using an image, wherein information by the interactive communication means is recorded in a recording medium such as a server system.

Further, the present invention provides interactive communication system and method using an image, wherein the interactive communication means with one to several persons using moving image and voice makes interactive communication with only one to several persons.

Further, the present invention provides interactive communication system and method using an image, including interactive communication means with one to several persons using moving image and voice,

various education, various sports, hobbies, recreations and other living environments being instructed in the form of interactive communication of substantially one instructor with one to several students.

Further, the present invention provides interactive communication system and method using an image, wherein the instructor himself is outputted to an instructor's PC using a moving image and/or voice, and the student himself is outputted to a student's PC using the same as above.

Further, the present invention provides interactive communication system and method using an image, wherein the sports include personal sports such as golf, fencing, tennis, table tennis, group sports such as baseball, soccer, basketball, martial arts such as sumo, wrestling, judo, boxing, sports co-existing with nature, such as surfing, skiing, skating, swimming or the like, and sports having targets, such as fishing, hunting, etc.

Further, the present invention provides interactive communication system and method using an image, wherein the hobbies include igo, chess, shogi, dancing, billiard, piano, gardening, and culture and recreations.

Further, the present invention provides interactive communication system and method using an image, wherein the living environments include various cares, cosmetic treatment, weight training, flower arrangement (ikebana), the art of flower arrangement, cooking, etc.

Further, the present invention provides interactive communication system and method using an image, wherein two images showing the instructor's performance or action and the student's performance or action are compared so that the student can understand a difference in action timing between the instructor and the student.

Further, the present invention provides interactive communication system and method using an image, wherein two images are still image, and two still images are compared so that the student can understand a difference in action between the instructor and the student.

Further, the present invention provides interactive communication system and method using an image, wherein one of the instructor's and student's images is displayed as a moving image, and the other thereof is displayed as a still image so that the student can understand the relation.

Further, the present invention provides interactive communication system and method using an image, wherein the instructor or student displays the instructor's or student's sports, performance or action on a PC as still image, and draws a line on the image along a basic line of body, and further, cancels the images showing the sports, performance or action, only plural basic line groups are displayed on one image in place of a moving image so that the student can understand a change of the basic line of body.

Further, the present invention provides interactive communication system and method using an image, wherein a video still image showing a performance or action is displayed, and then, the instructor draw characters or/and symbol into a part of the image so that the student can understand an instructed point.

Further, the present invention provides interactive communication system and method using an image, wherein a video still image including characters or/and symbol drawn by the instructor is copied so that the student can understand the instruction result with reference to the copy later.

Further, the present invention provides interactive communication system and method using an image, wherein the interactive communication means with one to several persons using moving image and voice by a network line has games including igo, chess, shogi with one to several persons.

Further, the present invention provides interactive communication system and method using an image, wherein the interactive communication means with one to several persons using the moving image and voice by a network line, further includes means for storing the moving image and voice in the receiver's PC in the case where no reception is made because a receiver is absent.

Further, the present invention provides interactive communication system and method using an image, wherein the interactive communication means with one to several persons using moving image and voice by a network line, further includes means for displaying a desired image of one to several persons displayed on the PC using a wide screen.

Further, the present invention provides interactive communication system and method using an image, wherein the interactive communication means with one to several persons using moving image and voice by a network line, displays graphics, photographs, characters such as text paper or image information, in addition to the moving image of one to several persons.

Further, the present invention provides interactive communication system and method using an image, wherein the interactive communication means with one to several persons using moving image and voice by a network line, further includes means, which is composed of substantially one examiner for employment and qualification test and one to several examinees, and displays a test question on a predetermined portion of the examinee's PC, and further, receives a test result including answers and questions from the examinee so as to take an examination from a remote place.

Further, the present invention provides interactive communication system and method using an image, wherein the interactive communication means with one to several persons using moving image and voice by a network line, further includes means, which includes substantially one interpreter displayed on other PC in interactive communication made in meeting, discussion, lecture and other languages or sign language by substantially one person.

Further, the present invention provides interactive communication system and method using an image, wherein the interactive communication means with one to several persons using moving image and voice by a network line, is capable of making transmission and reception using various mobiles such as cellular phone or the like, and a copy is made using a proper device anytime and anywhere, if necessary.

The objects, features and effects of interactive communication system and method using an image of the present invention exist much other than above, and belong to the technical scope of the present invention. These objects, features and effects will be further apparent from the following embodiments.

### BRIEF DESCRIPTION OF THE DRAWINGS

FIG. 1 is a view to explain a transmitter/receiver device using an image applied to the present invention;

FIG. 2 is a perspective view showing the transmitter/receiver device shown in FIG. 1;

FIG. 3 is a view showing an icon displayed on a PC;

FIG. 4 is a view showing a login input screen;

FIG. 5 is a view showing a PC screen after the login input;

FIG. 6 is a view showing a room list screen;

FIG. 7 is a view showing a password input screen;

FIG. 8 is a view to explain a member's screen having a partial wide function;

FIG. 9 is a view showing a member's list screen;

FIG. 10 is a view to explain a screen in which a picked-up image is displayed on a room;

FIG. 11 is a view showing one example of character chat;

FIG. 12 is a view showing a list screen showing member's login and logout;

FIG. 13 is a block diagram to explain an interactive communication system of the present invention using a LAN;

FIG. 14 is a block diagram to explain one embodiment of the present invention;

FIG. 15 is a view showing a screen in which images picking up instructor's front and side are displayed right and left for giving an instruction to user;

FIG. 16 to FIG. 18 is a view showing a screen in which a flow of instructor's golf form is sequentially shown for teaching a different in timing;

FIG. 19 and FIG. 20 are views showing a screen in which two still images are displayed in order to compare and study the instructor's front and side golf forms;

FIG. 21 to FIG. 23 is a view showing a screen in which one of two images displayed on the screen is displayed as a still image, and the other thereof is displayed as a moving image in order to simultaneously make comparison and study;

FIG. 24 is a view showing a screen for teaching a fishing trap by instructor;

FIG. 25 to FIG. 26 is a view showing a screen used for teaching and explaining the game of igo using the interactive communication system of the present invention;

FIG. 27 is a view showing a screen for teaching the way of sitting on chair for preventing lower back pain;

FIG. 28 is a view showing a scene of examination site; and

FIG. 29 is a block diagram showing the whole configuration of digital camera.

### DETAILED DESCRIPTION OF THE PREFERRED EMBODIMENTS

[Embodiment]

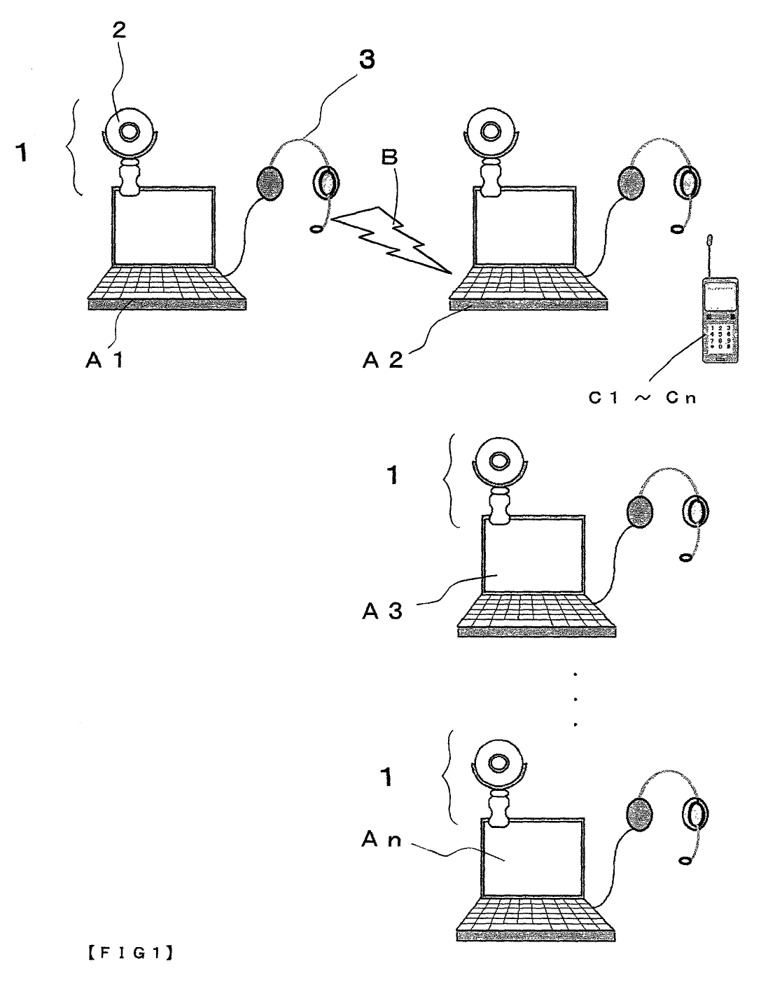

In FIG. 1, reference numerals (A1) to (An) are usually a personal computer (PC); for example, (A1) is self-PC, and (A2) is other person's PC. In this case, the PC is often used in a manner that the self-PC (A1) is used by an instructor; on the other hand, the PC (A2) is used by students. Further, the PC (A2) to (An) may be situated at remote places such as foreign countries with respect to the PC (A1); for example, these PCs are connected by a wired or wireless network line (B) such as Internet.

In this embodiment, the PC (A1) to (An) has the following specifications. More specifically, Windows 98, Windows 98SE, Windows Me, and Windows 2000 (trademark registered) are used as an operating system OS (basic software), and the CPU has Intel (trademark registered) Pentium (trademark registered) 2000 MHz or more. Further, an HDD has a free capacity of 20 MHz or more, a memory has 64 MB or more, and a 56K or more modem (e.g., ISDN Ethernet DSL (CATVE, etc.) is used as connect environment of multi-media, sound guard and network. Moreover, although this embodiment has described the case where the PC is used, of course, the present invention is not limited to the embodiment. For example, so-called mobiles (C1) to (Cn) such as cellular phones and mobile terminals may be used.

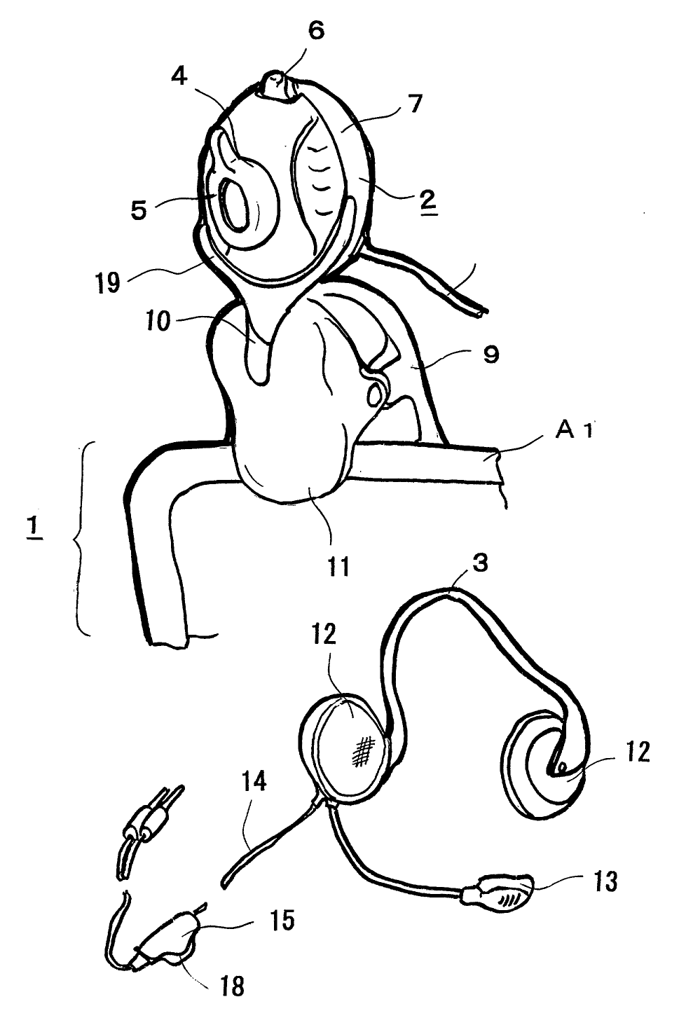

In FIG. 1, a reference numeral (1) denotes a transmitter/receiver device, which comprises a camera mechanism (2) and a transmitter/receiver mechanism (3). The camera mechanism (2) comprises a camera lens mechanism (4) and a stand mechanism (9) as shown in FIG. 2. Although the detailed illustration and explanation of the camera lens mechanism (4), a front knob (5) is turned, and thereby, a target can be made into a so-called zoom state or wide-angle state by well-know means.

A reference numeral (8) denotes a lead wire connected to the PC (A1). In the case of carrying out the present invention, a USB cable is used for a connection with the PC. The cable is not limited to the USB cable, and the present invention can be carried out even if ordinary cables are used.

In FIG. 1, a reference numeral (6) denotes a shutter (7) which is provided in the camera mechanism, and is pushed down from the upper portion. This shutter is pushed down when starting pickup; specifically, the shutter (7) continues to be pushed down, and thereby, image and/or moving image are properly picked up via the lens mechanism (4). The picked-up image and/or moving image are transferred to the PC via the lead wire (8), and then, are displayed on a monitor of the PC in real time. Therefore, the user releases the shutter at a proper position while confirming the image and/or moving image displayed on the PC, and thereby, completes the pickup.

The stand mechanism (9) is connected with the above camera mechanism (2) via a universal mechanism (10) provided at the upper portion, and has a fork-like clip (11) at the lower end portion. More specifically, the lower end portion of the camera mechanism (2) is attached with a frame (19) for holding the camera mechanism (2) at a predetermined angle. The frame (19) has a protrusion at the lower end portion, and its lowest end is formed into a shape of circle. The frame (19) is fitted into a recessed portion (10) formed in the stand mechanism (9), and thereby, the camera mechanism (2) and the stand mechanism (9) are connected to each other.

The transmitter/receiver mechanism (3) comprises a pair of earphones (12) wearable to human's ears, a small-size microphone (13) having one end attached to a frame of one earphone (12), a lead wire (14) connected to the above PC (A1) and a switch mechanism (15) provided on the midway of the lead wire (14). The other end of the lead wire (14) comprises voice input and output terminals. The voice input and output terminals are properly inserted individually into a connector of a voice input section (usually, a mark designing the microphone is displayed on the PC) and an output sections (usually, a mark designing the earphone is displayed on the PC) provided in the PC (A1). The switch mechanism (15) is provided with an analog volume control button (18) made by combining several kinds of gears in the case of this embodiment. For example, the switch mechanism may be provided with a volume control button incorporating a liquid crystal panel, or a digital volume control button using an electronic circuit.

A typical example in the case of carrying out the present invention will be detailedly described below. First, program software and driver for carrying out the present invention are correctly installed on the PC via proper means such as a CD-ROM or network delivery. The setup for installation is very simple; for example, in the case of installing the program software from the CD-ROM, when the CD-ROM is set in the PC, an install program automatically starts up. The user merely carries out a required software install operation according to a menu screen displayed on the PC. Further, in the case of using a network delivery or FD (Floppy Disk), the user may carry out the same operation as above.

Next, program software and driver for pickup using the camera mechanism are correctly installed on the PC. This overlaps with the above explanation; therefore, the details are omitted herein.

Further, the stand mechanism (9) of the camera mechanism (2) is fixed to the upper side of the PC (A1) by using the clip (11), the other end of the lead wire (8) is set to a proper position of the PC (A1). Thereafter, the other end of the lead wire of the transmitter/receiver mechanism (3) is set to a proper position of the PC (A1), and thus, a preparation for carrying out the present invention is completed.

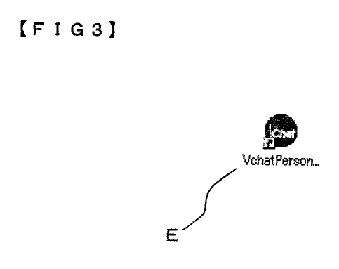

FIG. 3 shows a menu select screen for starting up the software of the present invention on a display of the PC (A1) When double-clicking a system icon (E) on the PC made by the above means (as shown in FIG. 3, the icon (E) has a design comprising a “Vchat” drawn in a circle, characters “Vchat . . . ” and an arrow drawn in square, positioned on the lower left-hand side, and is a so-called shortcut), the software program starts up. In the case where no shortcut is displayed on the screen, the software is started up in the following manner. More specifically, in the case of Windows (trademark registered) series used for carrying out the present invention, menus such as “start”, “program” and “VchatPersonal” are clicked in succession, and thereby, the software starts up.

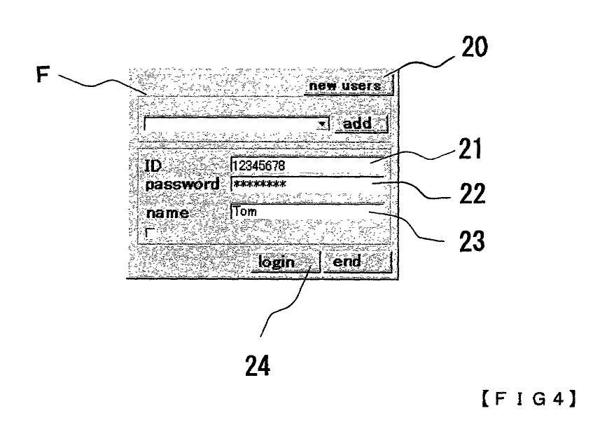

FIG. 4 shows a menu screen (F) displayed in logging in. When using the system of the present invention for the first time, there is a need of clicking a new user button (20) located at the upper portion in the menu screen (F) so that a setup of new registration is achieved. Although the setup method is not illustrated herein in particular, the user merely inputs his ID, password and name arbitrarily determined to a proper position of the above menu screen.

No special rule is given to these ID, password and name, and thus, it is preferable to express them by domestic languages such as alphabet, numerals, katakana, hiragana, or symbols such as # and &, and its combination.

The ID, password and name registered once are stored in a memory built in the PC; therefore, particularly, unless there is a problem, the ID, password and name registered once specify the user in future. In the case of using the system of the present invention after the second time, there is no need of carrying out the above-mentioned setup.

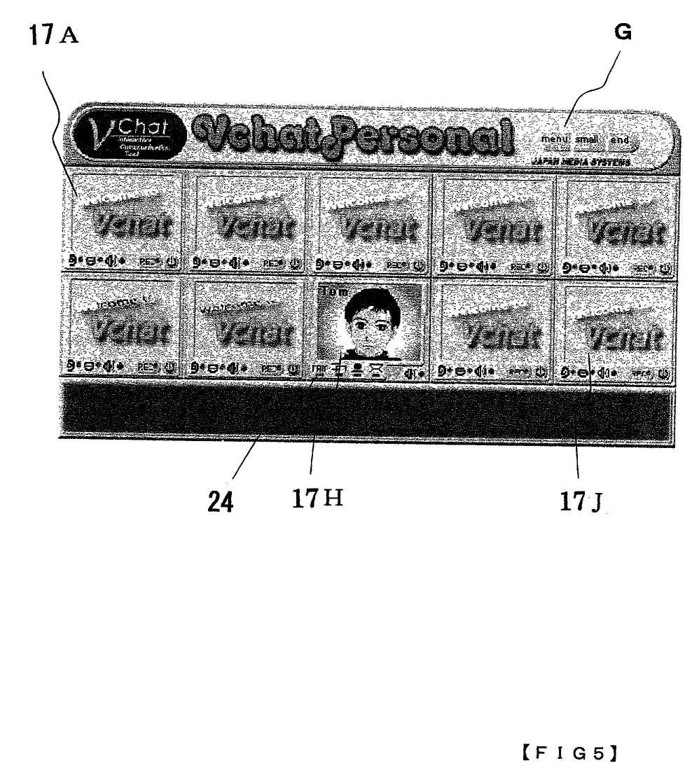

The above procedure for new registration is taken, and thereafter, the user inputs ID (21), password (22) and name (23) based on the indication of the menu screen (F) shown in FIG. 4, and then, clicks login (24). By doing so, the software of the present invention starts up, and then, a menu screen (G) as shown in FIG. 5 is displayed.

More specifically, a panel-like display screen is displayed on the display of the PC in this embodiment. The panel-like display section is usually called as chat room, and is partitioned into ten, in total, that is, (17A) to (17J). Further, the chat rooms are divided into five parts for each of up and down portions. The user is allocated to one (room 17H in FIG. 5) of the rooms.

In order to give information that the room (17) is allocated to third persons other than user, the name inputted in FIG. 4 is displayed on the upper portion of the room (17) or a proper image is displayed in the room (17). FIG. 5 shows the case where the user previously drawn using image saving format such as gif and bmp is displayed on the allocated room (17).

Although there is no special illustration in FIG. 5, when clicking a CAM button (24) provided on the lower left-hand portion of the room (17), an image file list stored in the memory of the PC (A) is previously displayed. Then, the user selects an arbitrary image from the image file list, and thereby, the selected image is displayed on the room (17). Of course, the image is not limited to the user, and any other forms may be used so long as the user is specified by the third persons. For example, the image includes animals such as cats and dogs, vehicles such as airplane and train, geometric patterns such as arrows and marks, photographs previously captured in the PC (A).

According to the embodiment of the present invention, using the previously set camera mechanism, it is possible to capture the image and/or moving image in the PC in real time while picking up the user's image or a target on which the user desires to pick up.

The following is a brief description on the pickup procedure. In the case of carrying out the present invention, a 30 ten-thousand-pixel high performance CMOS digital camera is used as the camera mechanism (2). The basic structure of the digital camera is as shown in FIG. 29, and any other form may be used so long as the digital camera includes the following elements. More specifically, the digital camera includes at least a lens for capturing an external image, a CCD image sensor, a pre-amplifier for converting the image into data, a color separator circuit, an analog processing circuit, a photometric circuit required for the analog processing, and a WB detection circuit (white balance detection circuit). Further, the digital camera includes a re-sampling circuit, an A/D digital processing circuit, a memory controller, a frame memory corresponding to the memory controller, a driver, a system controller used as main function for controlling these circuits, a timing pulse generator, and a memory for recording information.

In general, an image take by the digital camera is handled as JPEG format. The JPEG format is a effective recording format, which uses nature such as photograph as a target, and can compress a file size and transmission time by Internet while keeping an image quality. Therefore, the JPEG format is an adaptable recording format in the case of carrying out the present invention.

Subsequently, the following is a description on a method of capturing an image and/or moving image in the PC using the camera mechanism (2). First, the lens mechanism (4) provided on the camera mechanism (2) is directed to a target to be picked up. Then, the user continues to push down the shutter (7), and thereby, the image and/or moving image pickup starts. The data is transferred to the PC (A) via the leas wire (8) in real time while the image data being displayed on the PC. Thus, the user releases the shutter at a proper position while confirming the image and/or moving image displayed on the PC (A), and thereby, the image pickup is completed. In the case of out-of-focus, or in the case of adjusting a magnification, the user turns the knob (5) located on the front portion of the lens mechanism (4) and thereby, the target can be made into a so-called zoom state or wide-angle state by the well-know means.

Further, in the case of picking up the user himself, as described before, the stand mechanism (9) of the camera mechanism (2) is fixed to the upper side of the PC (A) by using the clip (11). If the target to be picked up is without a range of the lens mechanism (4), the user removes the fixed camera mechanism (2) from the PC (A), and then, may carry out the pickup while holding the camera mechanism (2) by his hand.

Of course, the image is not limited to a still image, and it is possible to capture a moving image. In this case, the user merely pushes down the shutter (7) of the camera mechanism (2) once, and thereby, the moving image pickup is automatically continued. Then, the user again pushes down the shutter (7), and thereby, the moving image pickup is completed.

Further, the target to be picked up is not limited to persons, and may be information to be visually transmitted, for example, articles such as commodities, maps, photographs, or art and molding works and pictures, as described later.

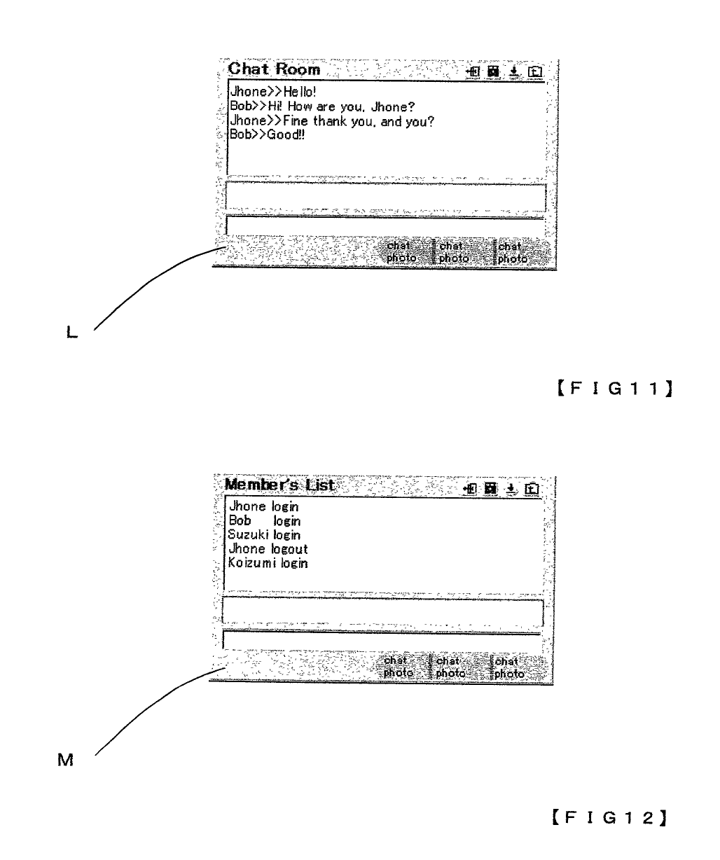

The image thus captured can be confirmed in an enlarged state (j) as shown in FIG. 8. Therefore, as shown in FIG. 10, the user clicks the CAM button (24) situated at the lower portion of the room (17I in FIG. 10) allocated to the user, and thereby, it is possible to display the image captured using the camera mechanism (2) on the room (17I).

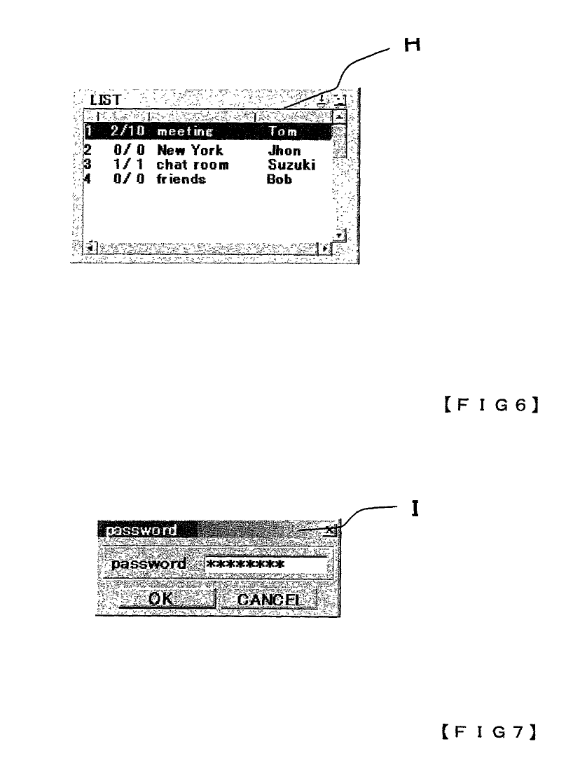

Subsequently, the following is a description on the case where the user has a conversation with the third persons joining in the chat room using the system of the present invention (the case of having a so-called chat). First, a previously registered room list menu screen (H) as shown in FIG. 6 is displayed together with the menu screen shown in FIG. 5. In this case, in the room, a room administrator called as a room leader previously sets a theme on which he desires to chat and a room name. On the other hand, the user selects an arbitrary room from the displayed rooms (in FIG. 6, the selected room makes reverse display), and thereafter, enters the selected.

Further, using the system of the present invention, meeting is conduced between the main office and branch office of the company, or it is possible to have a private talk between males and females. In the case where the room leader desires to refuse the user's participation to the room, preferably, the room leader can previously set a password to enter his room.

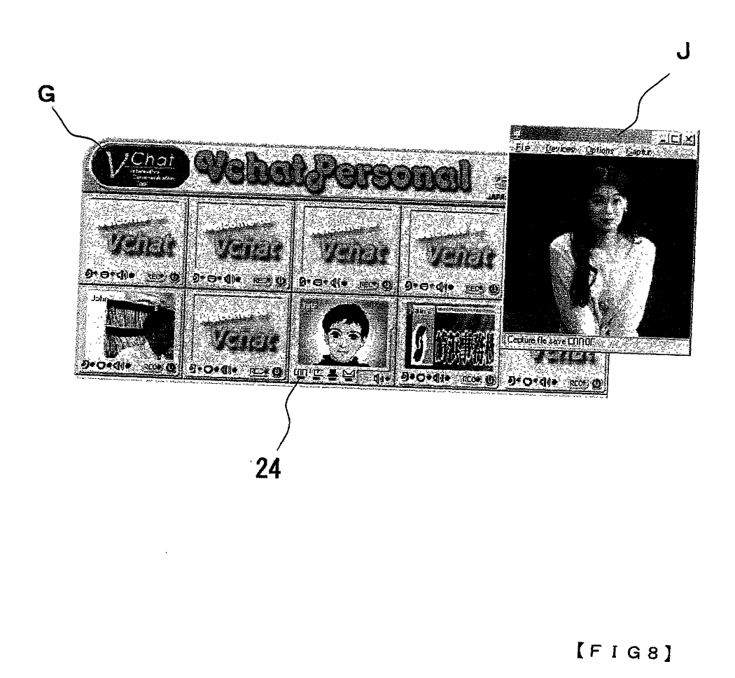

FIG. 7 shows an input screen (I) for inputting a password. Only when an inputted password coincides with the password previously set by the room leader, the user can enter the above selected room; namely, the user can join the chat. Although no illustration in FIG. 7, if the user mistakes the password input, or makes insufficient password input, of course, the enter to the chat room is refused.

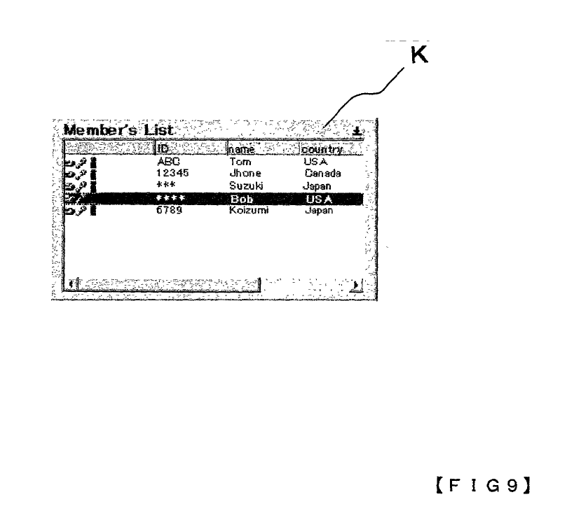

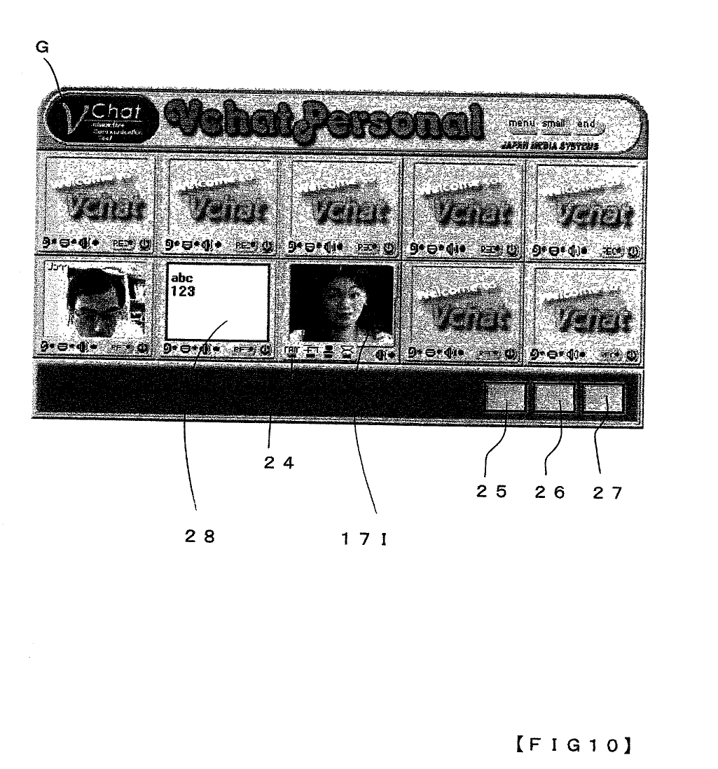

In the manner as described above, when a member allowed entering the room is specified, the member is listed as shown in a menu screen (K) of FIG. 9. Therefore, the user can confirm the member joining ten rooms (17) on the screen of the PC. In this case, it is possible to preset a room leader (in the case of FIG. 9, the room leader column makes reverse display, and is displayed by an outline type character). However, in general, the room leader is a person, who has made a chat room and collected other users. In addition, the room leader has various authorizations, and the details will be described later.

In FIG. 10, reference numerals (25), (26) and (27) are click buttons provided at the lower right-hand portion of the above rooms (17A) to (17J). In FIG. 10, the left-hand side button (25) has the following functions as a telephone icon (e.g., green: same as below), a camera icon (green), audio transmission, and video simultaneous transmission when continuing to push the button. Further, the central button (26) has the following function as a telephone icon (green), a camera icon (red), and a video transmission stop during audio transmission when continuing to push the button. Further, the right-hand side button (27) has a function as telephone and camera icon (radio wave) and capable of always transmitting audio and video. Thus, the user arbitrarily selects and uses the above functions, and then, makes an exchange with other users joining the chat using the earphone (12) and the small-size microphone (13) provided in the transmitter/receiver device (3). By doing so, the user can have a chat in the manner of calling on the phone, and thus, the present invention is carried out, and the system is completed.

Moreover, in the case where a deaf and mute person joins the chat as a user, the present invention has a chat system using well-know characters without hindrance to the joined deaf and mute person. In this case, the deaf and mute user inputs sentences to a proper position of a menu screen (L) shown in FIG. 11 by typing (word processor input), and thereafter, click a transmission button, and thereby, character information can be disclosed with respect to other users. The character information is added every when the sentence is transmission from above to below as time elapsed; therefore, the user can join the chat by reading the character information from above to below. Further, by using the IRC described before, in addition to users connected to the same server, users connected to other server belonging to the same IRC network can also enjoy the chat.

A Hyper Text Markup Language HTML may be used as a language saving format. The HYML is one of DTD of SGML (Standard Generalized Markup Language), and is the standards for a descriptive method of giving a symbol called as “tag” indicative of sentence characteristics (logical semantics) to the sentence. DTD (Document type Definition) is used as determining the kinds of tag. The HTML is regarded as one of the DTD.

The HTML has a function of associating documents connected by the network all over the world, and making a computer analysis using them as useful information. Even if the environmental condition of computer is different, in order that everybody has the information in common, the HTML has been considered as a method such that only semantic position such as “header” is added as information, and software displays characters in accordance with reader's environment, and is never the method of designating characters depending upon environments. Therefore, the HTML is the optimal saving format file in the case of carrying out the present invention.

In FIG. 10, a reference numeral (28) is a whiteboard, and the white board (28) is displayed on the room (17).

In this case, the user can write characters, graphics, graphs and tables in the whiteboard (28), like well-known office whiteboard and electronic blackboard, generally used. As the need arises, it is possible to partially erase or clear the written characters by using an eraser function.

In the case of using the above whiteboard (28), a web escort function is used in this embodiment of the present invention. The web escort function is a function of browsing a web page from the whiteboard (28), and writing characters or the like in the web page like the whiteboard (28). In order to use the above function, a browser having Internet Explorer 5.5 or more must be previously installed in the PC (A). If Netscape Navigator is used as the browser, no operation is made; therefore, a care should be taken in the case of using the above function.

Further, in the case of using the above whiteboard (28), preferably the room leader has the following authority. More specifically, when the room leader uses the web escort function, other user's whiteboard (28) is automatically changed into a web escort screen; therefore, inspection is possible with respect to the web escort screen. In this case, unlike the above whiteboard (28) display function, other users can not have their write, and can make only inspection; therefore, the room leader can have write and deletion without being hindered from other users.

In the present invention, the user can freely logs in out the room at an arbitrary time. The user's login and logout to the room are displayed on the user's PC (A) as shown in a menu screen (M) of FIG. 12; therefore, the user can always grasp the number of users currently joining the room, user's name, the sequence of login and logout while watching the screen. In particular, a new user's image is displayed on each room together with a message display “Mr. So-and-so appeared in this room” (not shown), and thereby, other users take a great interest in the new user.

As described above, according to the present invention, the user's image is displayed, or arbitrary something on which the user hopes is picked up, and then, is displayed as an image. Simultaneously, communicating other user's image is displayed, so that the user and other users can make interactive communication while seeing their facial expression and gesture. Therefore, audio-visual communication is carried out in real time, and facial expression, voice and characters are directly transmitted, and thereby, the communication contents and information exchange have reliability. Further, a network line via a provider is used, and thereby, even if a person, who makes communication, exists in a remote place such as foreign countries, it is possible to enjoyably make interactive communication at a low cost.

[Embodiment 1]

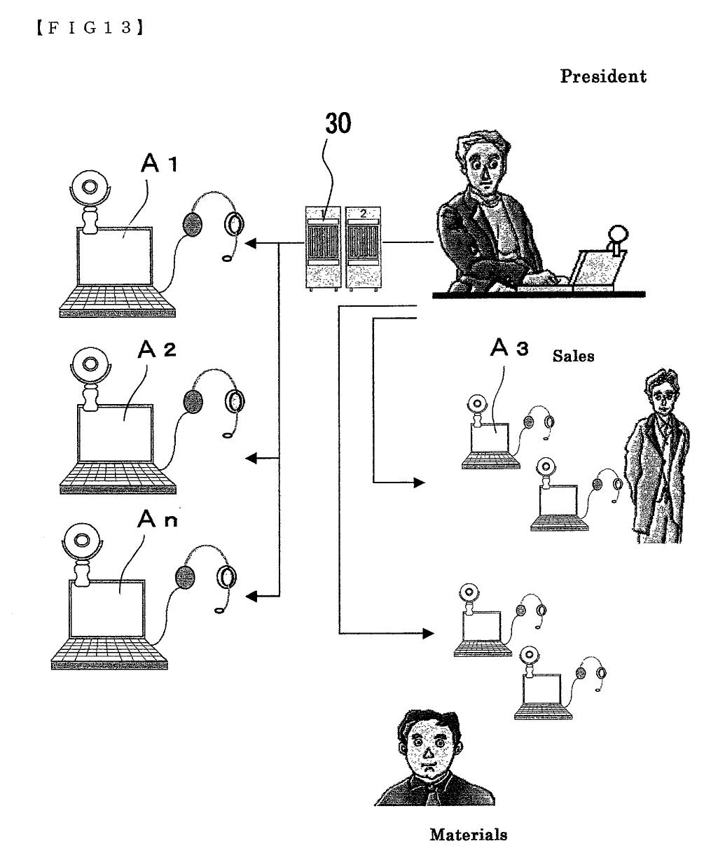

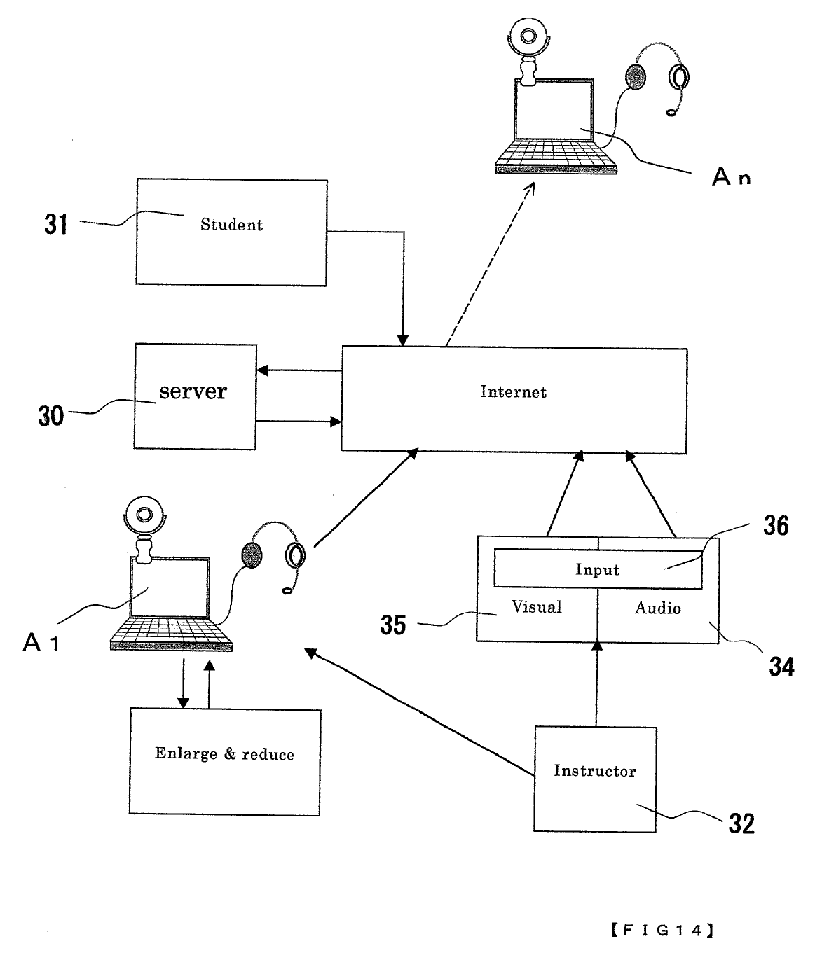

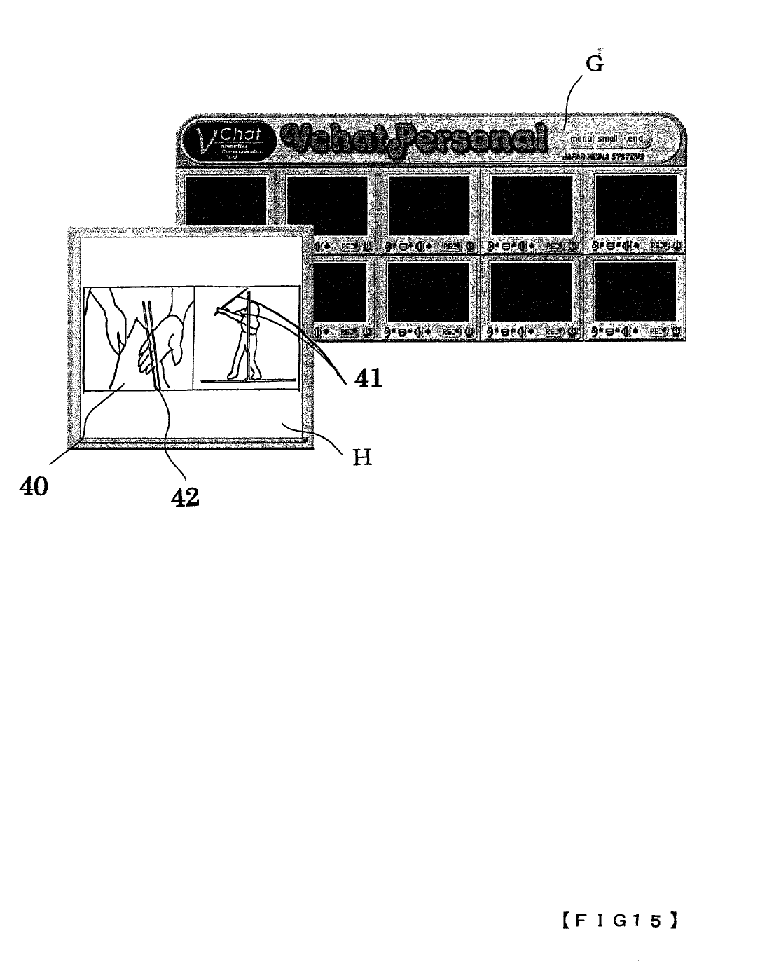

As shown in FIG. 13, a local area network (LAN) is used, and thereby, this interactive communication means is suitable for meeting of person in charge of branch office, business office, factory, warehouse positioned at a remote place; therefore, there is no need of going to a predetermined place specially.

The communication means is not limited to the above sections. For example, management stuff, sales, development, and planning departments are connected by using the above LAN, and thereby, an instruction from the president is given by an image to which his facial expression is added, together with his voice. Thus, the very useful effect can be obtained.

Further, questions and proposals to the president's instruction are directly made, and then, the result is recorded in a server (30) added to a part of the above LAN so that it can be always fetched as the need arises.

The present invention is not limited to this embodiment. For example, it is preferable that a person, who is now talking, is displayed automatically or manually as the wide screen (J) shown in FIG. 8 by well-known means such as wide screen mode.

[Embodiment 2]

Now, about nine patients, who have herniated, have a meeting with respect to one orthopedist. In this case, for example, the orthopedist has the following conversation means. More specifically, in the case of making generally common inquiries such as “how does hernia happen” or “matters to be daily paid attention”, the orthopedist makes communication with all people. On the other hand, in the case of making a personally secret conversation such as “personal condition” or “plan to go to and go out of the hospital”, the orthopedist makes communication with only person himself. Automatic password input, preparation and management are possible using well-known software such as Quick Pass PRO, and thereby, a password function can be built in the PC. By doing so, it is possible to have a chat between individuals by the PC having the password function thus built-in and communication system function.

[Embodiment 3]

This embodiment performs a excellent function in the case of making a communication of substantially one instructor with a plurality of students. FIG. 14 is a flowchart showing one example of a basic configuration of the present system.

By using the present system, a student (31) in Japan can directly receive an instruction from an instructor (32), who is resident at a remote place such as America. The instructor's (32) status is picked up by using the camera mechanism (2), and thereby, this embodiment of the present invention can be described.

The following is a description on the case where this embodiment is applied to golf lesson. First, an instructor (32) such as a lesson professional can give instructions to the student by a moving image (35) such as golf swing form using the camera mechanism (2) or by an input of his voice (34) using the transmitter/receiver mechanism (3). The status is outputted to the PC (A) via Internet (36), and then, instructions are directly given to the student via the transmitter/receiver mechanism (3), so that the student (31) can readily learn the instructor's grip and instructor's form with the grip.

The inquiry and proposal to the above instruction are directly made, and the result is recorded in a server (30) added to a part of the above LAN so that it can be always fetched as the need arises.

FIG. 15 to FIG. 20 is views showing one embodiment of the present invention, and shows the case where the present system is applied to golf lesson. In golf, an instruction such that don't move head position in golf club swing is often given to a golf player; however, even if the player observes a playing golf screen, the player can not have sufficient understanding. FIG. 15 shows a state enlarging a part of room (17) using the wide screen (J). As shown in FIG. 15, the instructor himself or the third person draws plural lines (42) for leading correct grip and form in a screen, and thereby, the observer can easily obtain his understanding. The student can not obtain such understanding by only voice means; namely, the student can obtain such understanding for the first time by using both voice and image.

In FIG. 15, the entire image (41) of the instructor's (32) take-back is displayed on the right-hand side of the menu screen, and a state zooming up the instructor's grip portion (40) is displayed on the left-hand side thereof. In the above manner, the student can confirm instructor's grip and take-back states while comparing them without overlapping two screens, and this is included in the scope of the present invention.

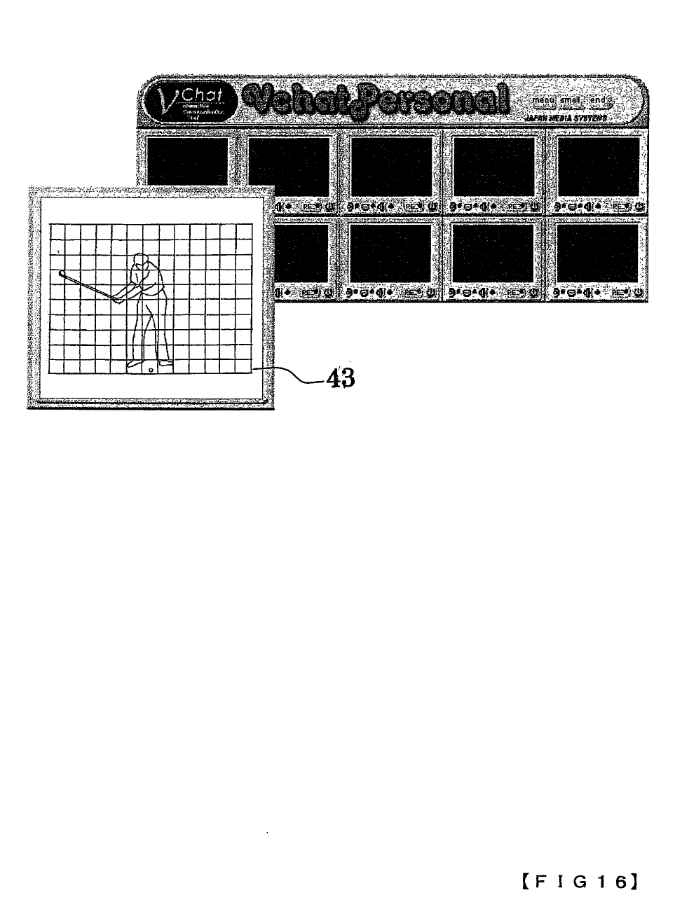

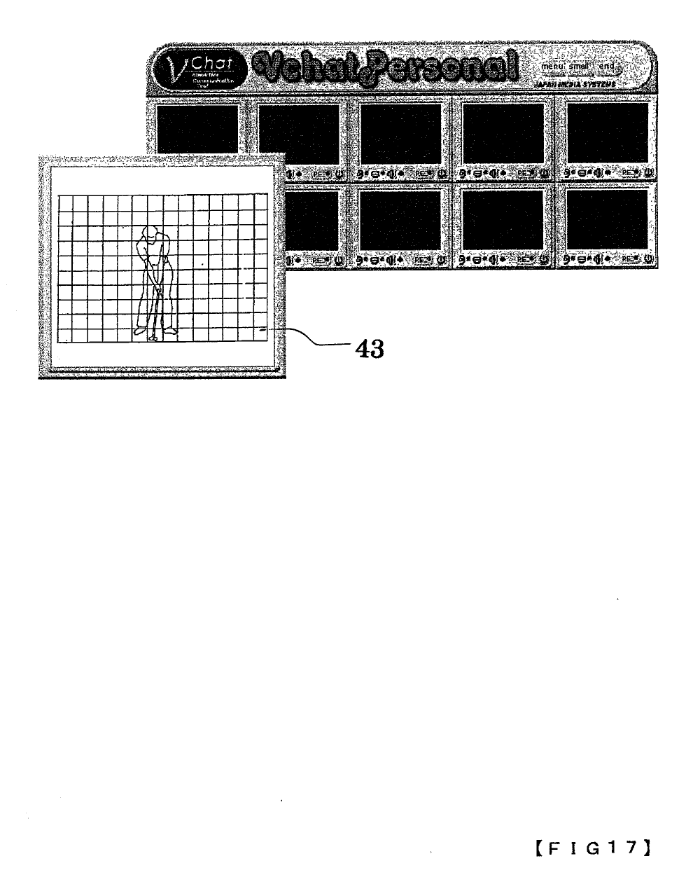

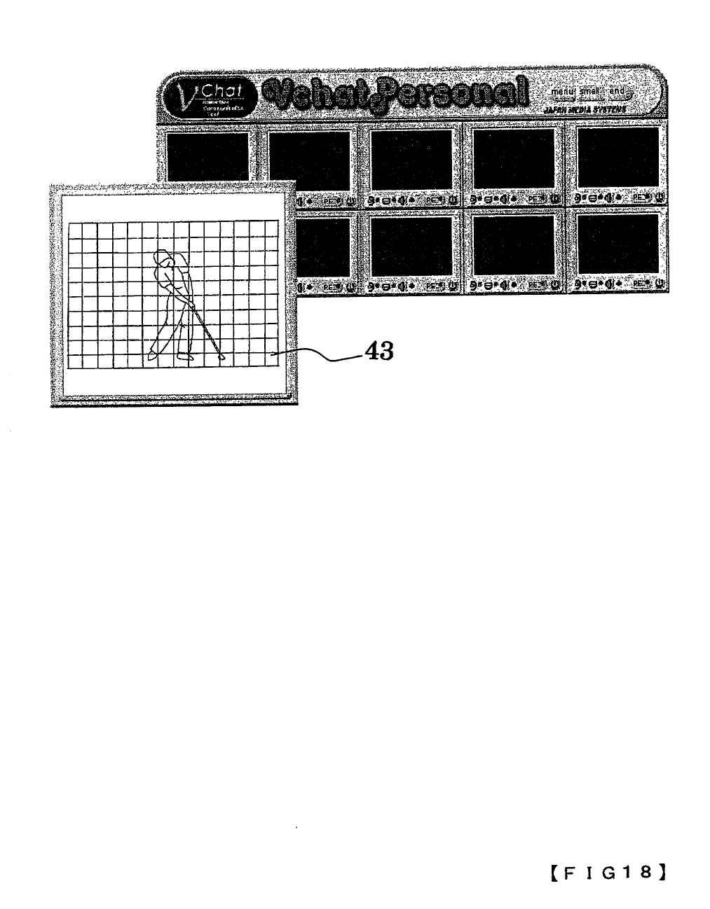

FIG. 16 shows a golf address state, FIG. 17 shows a take-back state, and FIG. 18 shows a state just after hitting a golf ball. In this case, a lattice line (43) is drawn in the instructor's screen (room) and the student's screen as the need arises, and thereby, the student can readily understand the instructor's golf form.

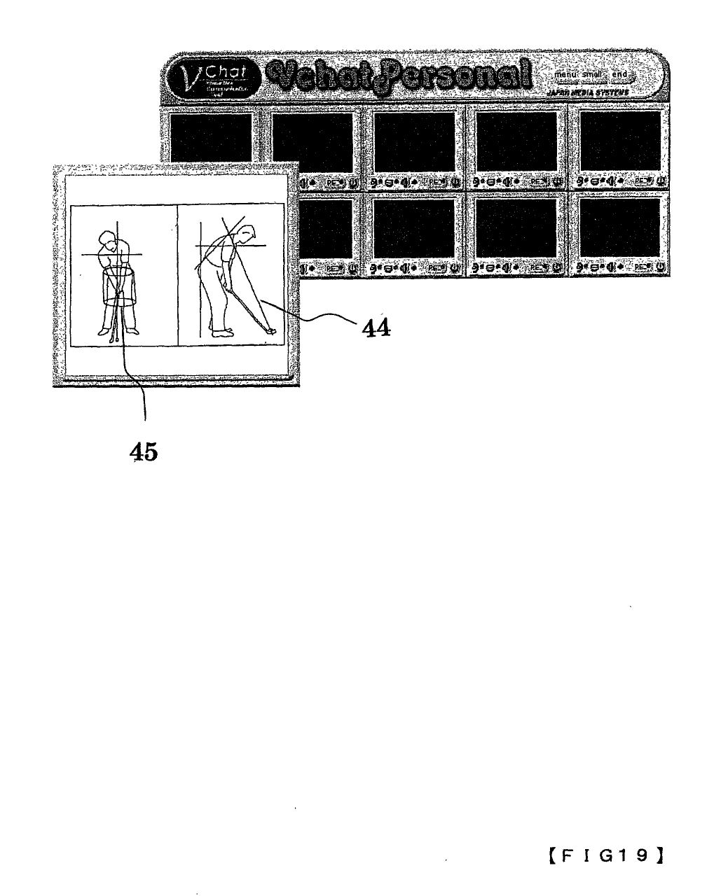

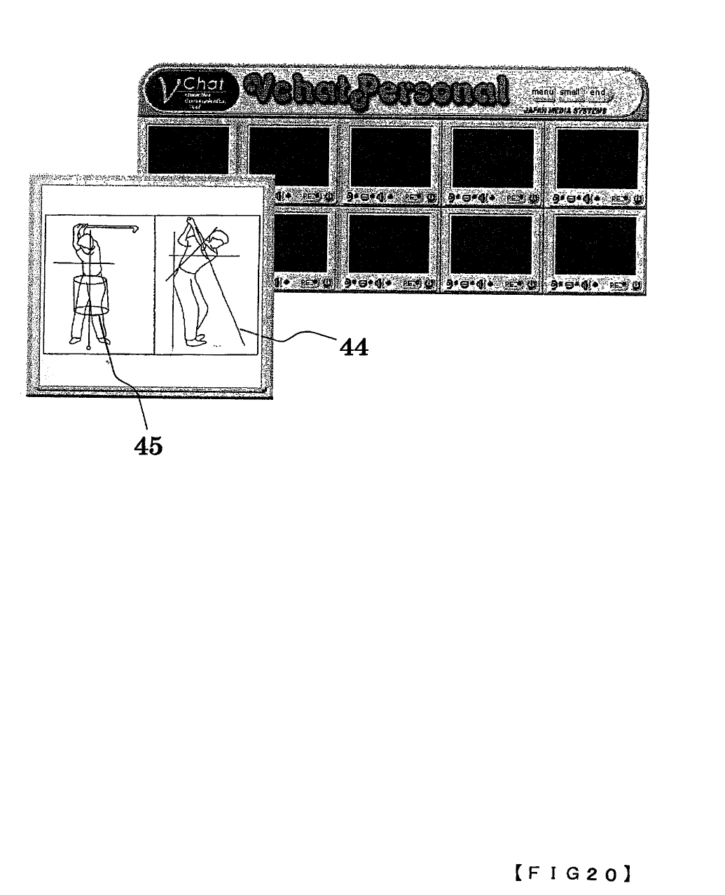

Further, as shown in FIG. 19 and FIG. 20, the same instructor is simultaneously picked up from different position, and then, a moving image (direct form) and a still image (e.g., past image fetched from the server), or two moving images are displayed, and two still images are displayed without overlapping with each other in the identical screen. In addition, a line (44) or circle (45) is used so as to express an inclination and an optimally movable range.

As described above, various instructions are given by using the system of the present invention, and thereby, the student can readily understand a correct form; therefore, a preferable instruction effect can be obtained.

[Embodiment 4]

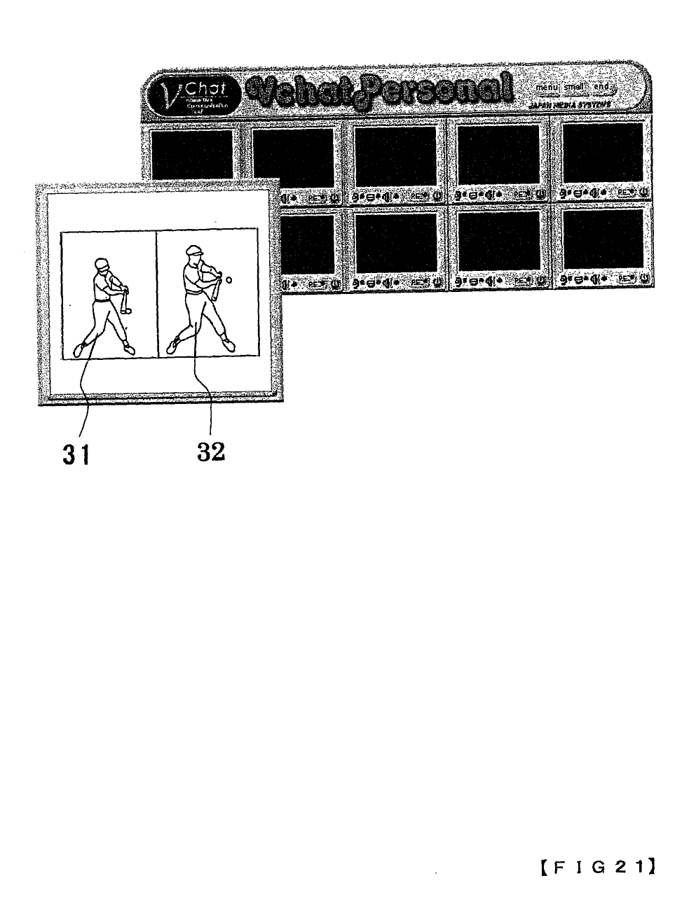

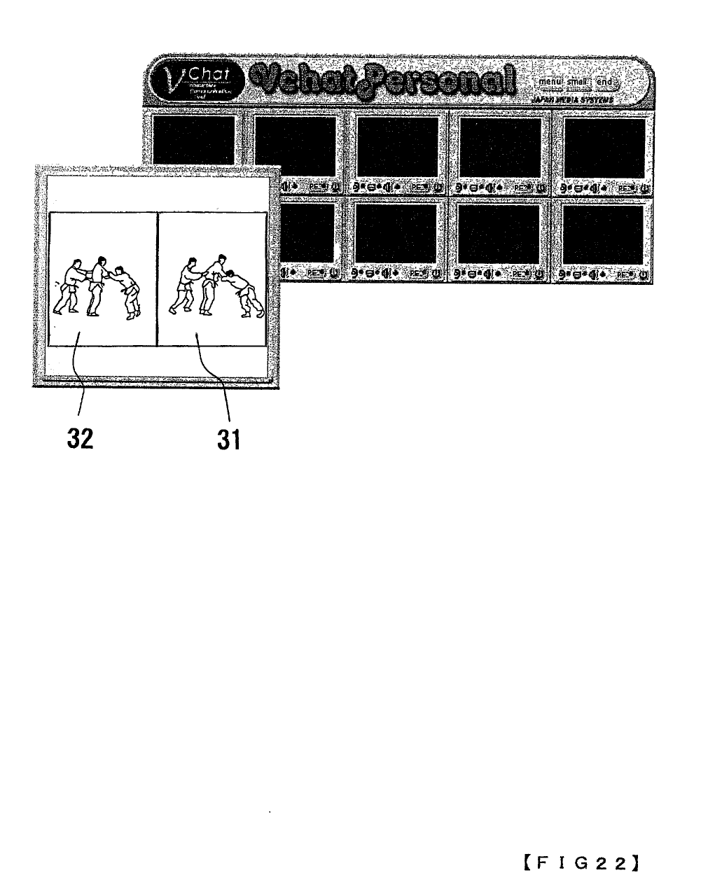

Of course, the embodiment is not limited to golf. FIG. 21 shows the case where the system of the present invention is applied to baseball, in particular, batter's swing. The right-hand side of the screen shows an instructor' batting form (32), and the left-hand side thereof shows student's batting form (31). These two forms are directly picked up, and then, are both fetched as still image. This is used to give an instruction for batting form of a batter hitting a ball thrown by a pitcher.

In this case, the screen shows a batting form just before a ball and bat contact with each other. In this moment, the left side batter's (student's) elbow is extended. An instruction is given to the student by using the system of the present invention, and thereby, the student confirms his defects; as a result, it is possible to make the student's form into a correct form. Thus, a preferable instruction effect can be obtained.

[Embodiment 5]

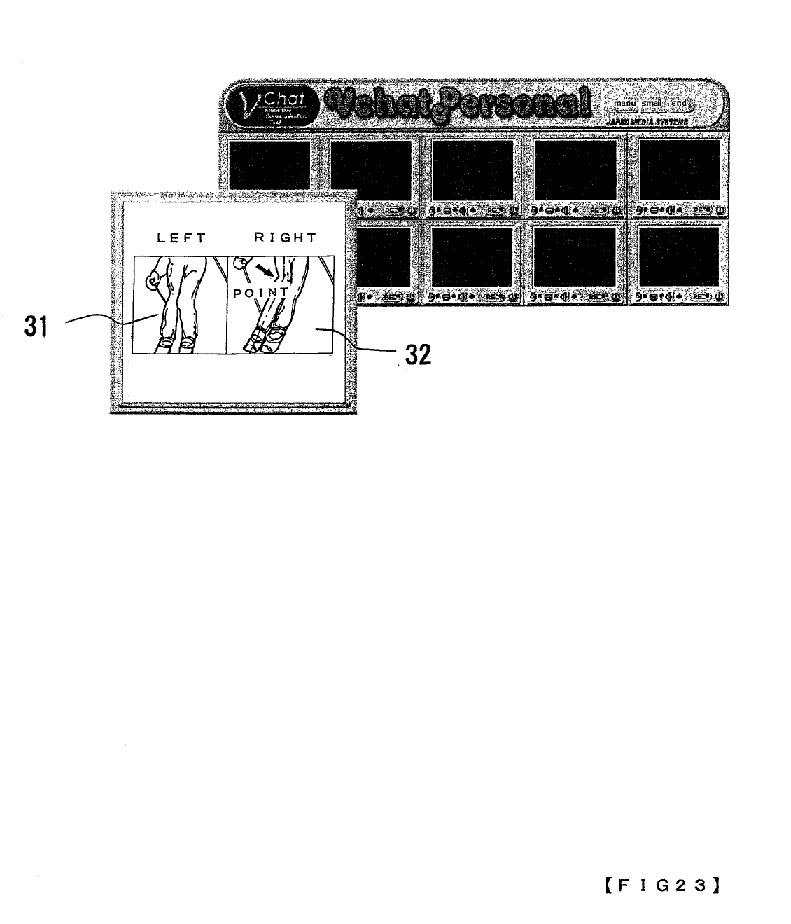

FIG. 22 shows the case of judo, more specifically, the case of giving an instruction of a so-called “form (kumite)” forming a team of three each using the wide-angle means of the camera mechanism (2). The left-hand side of the screen shows instructor's (32) demonstration, and the right-hand side thereof shows student's (31) play using still image, and thereby, the difference between two images is taught to the student via instructor's voice. When the teaching is completed, the next student's (31) play is displayed to make comparison as the instructor's (32) image is unchanged, and thereafter, the difference between two images is taught to the student in succession.

FIG. 23 is images showing instructor's (32) leg state in ski descent (right side) and student's (31) leg state (left side). In this case, the way of knee is the most important point; therefore, in order to clarify the way of knee, the character “point” is drawn in the instructor's image, and written instructions are added thereto. By doing so, the student can readily understand the skiing technique.

[Embodiment 6]

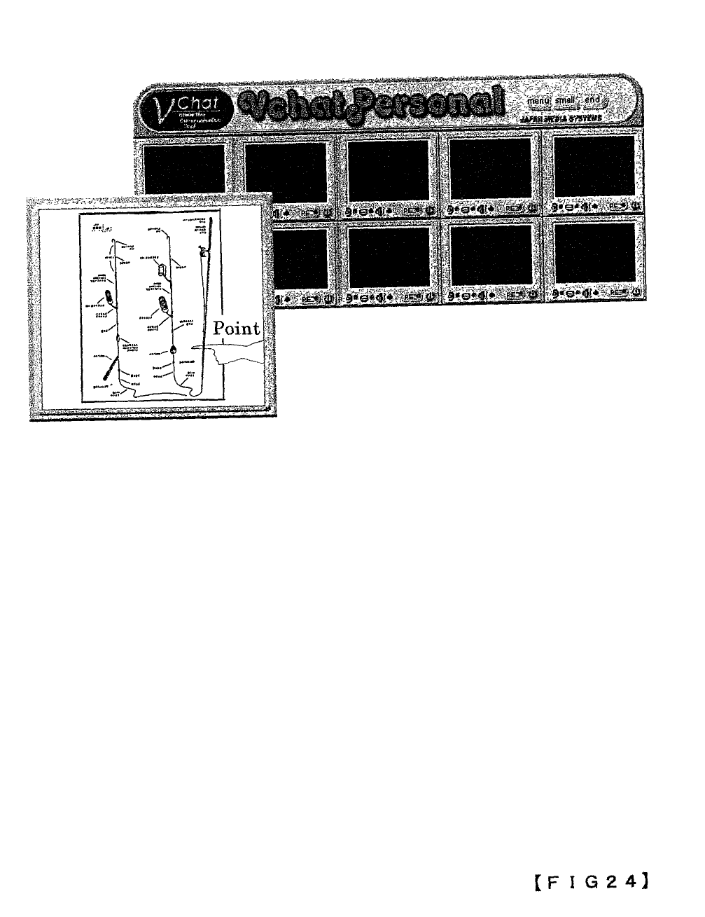

This embodiment is not only applied to how to use the instructor's (32) body as described above, but also may be applied to the following case. For example, as shown in FIG. 24, an instructor (32) shows fishing trap (for bonitos in FIG. 24), and then, the student makes the fishing trap taught by the instructor on the site. Further, the student can make a question about indefinite points using voice; therefore, a preferable instruction effect can be obtained.

[Embodiment 7]

In particular, the system of the present invention is greatly effective in hobbies such as igo, chess, shogi, dancing, billiard, piano and gardening, culture and recreation field, and serves to attract the user's interest.

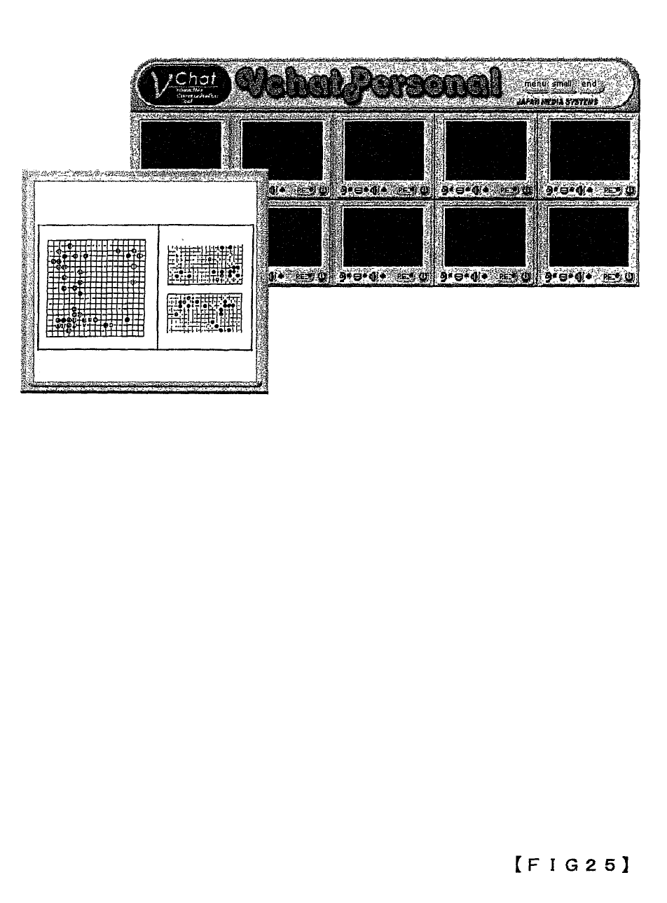

More specifically, in FIG. 25, there is shown the case of playing igo, and igo lovers in Japan and America can play igo while enjoying conversation and watching player's facial expression. Further, Internetwork is used, and thereby, communication cost becomes very cheap as compared with the case of using a general telephone line.

In this case, in addition to an image showing the game of igo on the right-hand side of the screen of FIG. 25, as shown in an image on the left-hand side, the instructor or commentator can give instructions such as opinions about the game or the next move to the student. At that time, it is preferable to make no display instructor's and player's voice, and to display no image shown as above on the player's PC.

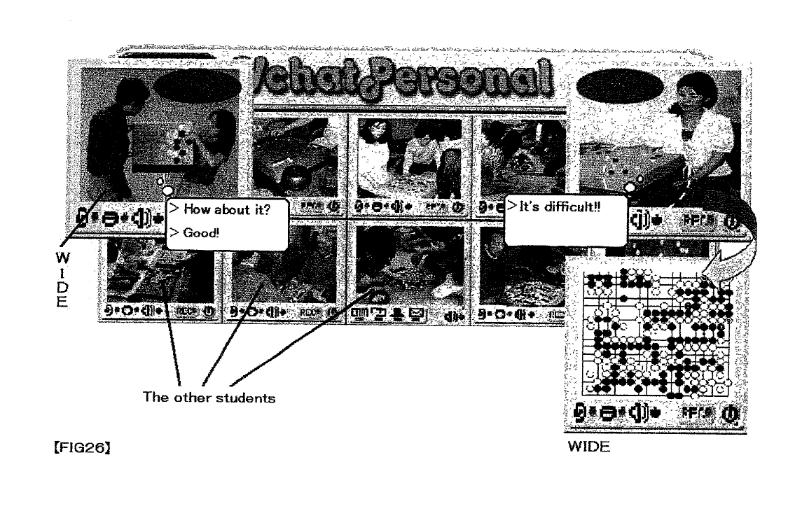

FIG. 26 shows a state further expanding the instruction of playing igo, and shows instruction method of simultaneously playing six 6 games of igo or ten 10 games of igo. As seen from FIG. 26, the instructor sees student's igo-board (ten persons in this case), and then, plays the next move in succession. Occasionally, the instructor gives messages such as “this move is good” or “you are well versed in form” to the student. Therefore, the instructor can give his instruction to the students existing all over the world.

[Embodiment 8]

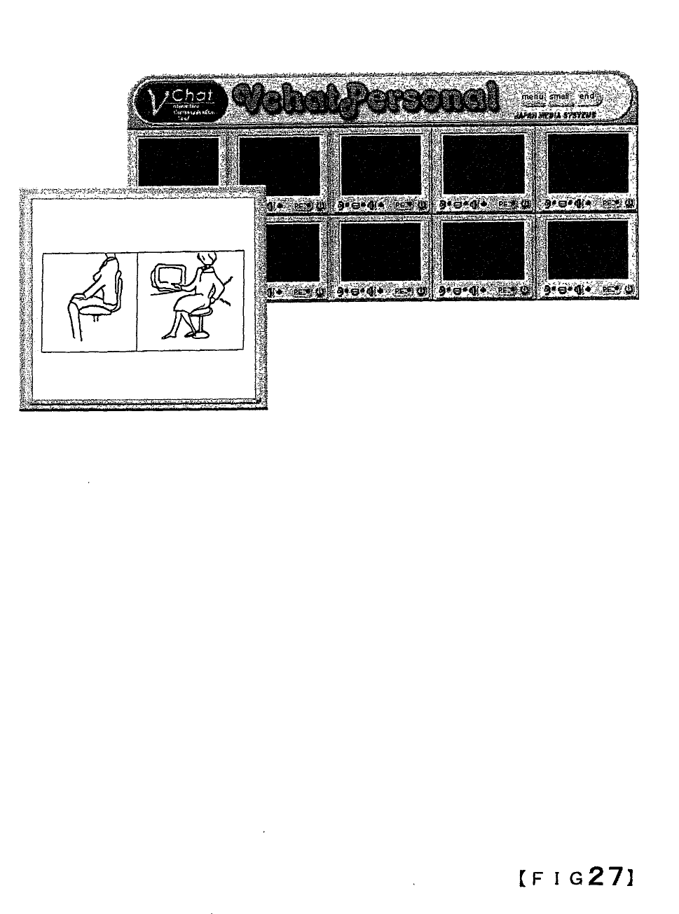

FIG. 27 shows a state that a medical specialist gives instructions to a patient, who has a lower back pain (hernia), using an image and voice. In FIG. 27, the medical specialist gives instructions such as a correct posture suitable for hernia and how to sit on chair for the care of hernia. The patient (student) sees the image, and thereby, he can obtain the understanding of the correct posture at once.

Incidentally, in the medical field, the patient has a personal inquiry, which should be hesitate to be heard by other persons. In this case, the well-known password function is used and thereby, it is possible to realize a function of temporarily cutting off a voice other than the questionnaire and his image as the need arises.

[Embodiment 9]

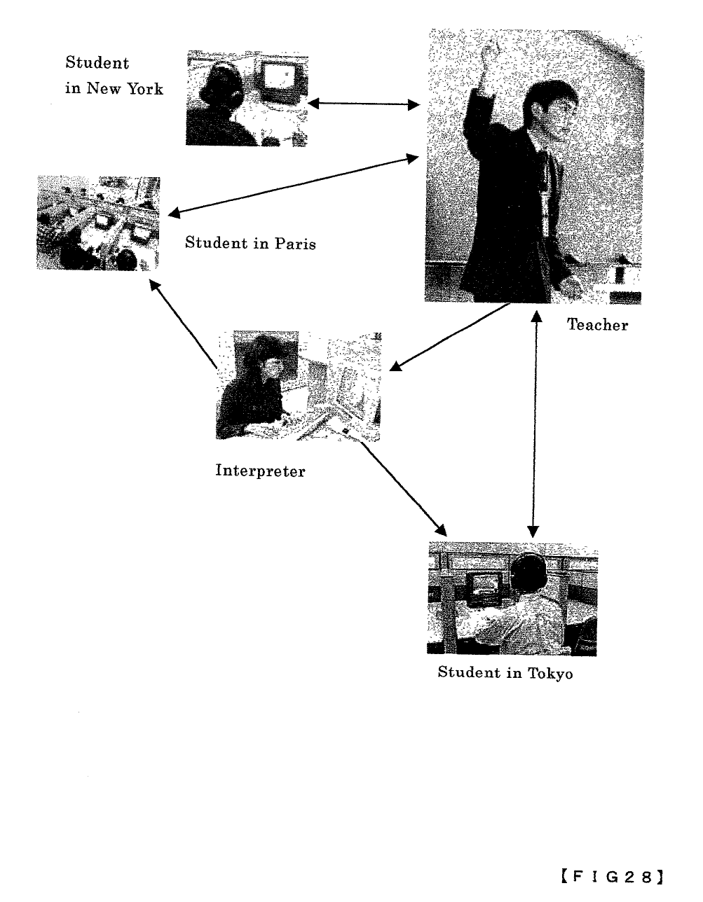

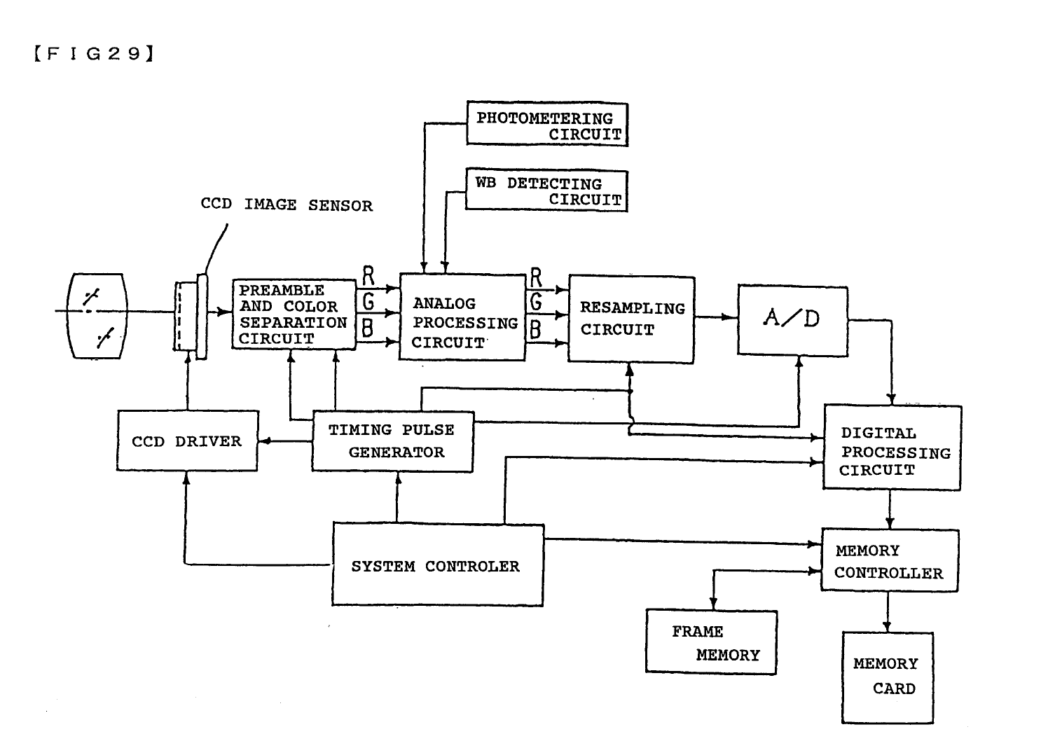

FIG. 28 shows an example in which the system and method of the present invention is applied to a lecture at school or various tests. The student (applicant) takes various examinations and lectures (curriculums) while being resident at his home.

In this case, an interpreter is interposed in the network line between the instructor's (teacher's) PC and the student's PC, and thereby, it is possible to reduce a load by language. In particular, an interpreter of sign language is interposed, and thereby, the deaf and mute persons can use the sign language as a second sound.

The above embodiments have described the case where the present invention is carried out using the PC. Of course, in the case of carrying out the present invention, so-called mobiles such as cellular phone may be used.

As described above, the system of the present invention is connected with a wired and wireless LAN or/and network line including standalone or Internet, and then, is usable in combination with character chat, real video image, voice, text, photograph mail or the like. Further, the system of the present invention is adaptable for various Internet environments; therefore, the present system is usable at various places such as domestic country, foreign countries, company, home, place where user goes out, so long as it is connected with Internet.

Further, in addition to the video meeting and medical consult detailedly described in the above embodiments, the present invention is applicable to legal consult, tax consult, financial plan, help desk, temporary employment business, security system, wedding consult, religious organization. The periodic meeting is conducted using the system of the present invention, and thereby, it is possible to reduce a travel fare, hotel charges, and transit time. Besides, recording and videotape recording function are used, and thereby, the minutes of meeting can be accurately recorded; therefore, the present invention is applicable to business negotiation.

Furthermore, the system of the present invention is applicable to the case of providing learning environments such as home room with foreign sister school, social field trip, parent consult and language education regardless of places. Besides, recording and videotape recording function are used, and thereby, it is possible to freely review lessons at favorite time.

Of course, like the usually used chat, the user may personally join the chat, and the following is a description on the merits in the case of using the present invention.

1. Ten persons simultaneously can have a chat.

2. The user can see other user's face while hearing his voice; therefore, the user can have a chat safely even if he met other users for the first time.

3. The password is set with respect to secret talk; therefore, it is possible to protect user's privacy.

4. Mobile communication such as note type personal computer and cellular phone is used, and thereby, it is possible to make a report in real time from the places where the user has trip and business trip.

5. Internet is used, and thereby, a communication charge is reduced, and further, it is possible to enjoy a chat with friends resident at a remote place.

What is claimed is:

1. Interactive communication system and method using an image, including interactive communication means using moving image and voice by a network line.

2. Interactive communication system and method using an image according to claim 1, wherein the interactive communication means is means, which can make simultaneously interactive communication with a plurality of persons.

3. Interactive communication system and method using an image according to claims 1 and 2, wherein the interactive communication means includes interactive communication means complexly combining characters, graphics, photographs or the like.

4. Interactive communication system and method using an image according to claims 1 to 3, wherein the interactive communication means has a local area network (LAN), which is connected to a network line.

5. Interactive communication system and method using an image according to claims 1 to 3, wherein information by the interactive communication means is recorded in a recording medium such as a server system.

6. Interactive communication system and method using an image according to claim 2, wherein the interactive communication means with one to several persons using moving image and voice by a network line makes interactive communication with only one to several persons.

7. Interactive communication system and method using an image, including interactive communication means with one to several persons using moving image and voice by a network line,
various education, sports, hobbies or recreations and other living environments being instructed in the form of interactive communication of substantially one instructor with one to several students.

8. Interactive communication system and method using an image according to claim 7, wherein the instructor himself is outputted to an instructor's PC using a moving image and/or voice, and the student himself is outputted to a student's PC using the same as above.

9. Interactive communication system and method using an image according to claim 7, wherein the sports include personal sports such as golf, fencing, tennis, table tennis, etc.

10. Interactive communication system and method using an image according to claim 7, wherein the sports include group sports such as baseball, soccer, basketball, etc.

11. Interactive communication system and method using an image according to claim 7, wherein the sports include martial arts such as sumo, wrestling, judo, boxing, etc.

12. Interactive communication system and method using an image according to claim 7, wherein the sports include sports existing with nature, such as surfing, ski, skate, swimming, etc.

13. Interactive communication system and method using an image according to claim 7, wherein the sports include sports having a target, such as fishing, hunting, etc.

14. Interactive communication system and method using an image according to claim 7, wherein the hobbies or recreations include igo, chess, shogi, dancing, billiard, piano, gardening, and culture and recreations.

15. Interactive communication system and method using an image according to claim 7, wherein the living environments include various cares, cosmetic treatment, weight training, flower arrangement (ikebana) the art of flower arrangement, cooking, etc.

16. Interactive communication system and method using an image according to claim 7, wherein two images showing the instructor's performance or action and the student's performance or action are compared so that the student can understand a difference in action timing between the instructor and the student.

17. Interactive communication system and method using an image according to claim 16, wherein two images are still image, and two still images are compared so that the student can understand a difference in action between the instructor and the student.

18. Interactive communication system and method using an image, wherein one of the instructor's and student's images is displayed as a moving image, and the other thereof is displayed as a still image so that the student can understand the relation.

19. Interactive communication system and method using an image, wherein the instructor or student displays the instructor's or student's sports, performance or action on a PC as still image, and draws a line on the image along a basic line of body, and further, cancels the images showing the sports, performance or action, only plural basic line groups are displayed on one image in place of a moving image so that the student can understand a change of the basic line of body.

20. Interactive communication system and method using an image, wherein a video still image showing a performance or action is displayed, and then, the instructor draw characters or/and symbol into a part of the image so that the student can understand an instructed point.

21. Interactive communication system and method using an image, wherein a video still image showing sports, performance or action made by the student is displayed, and the displayed image is stored as hard copy so that the student can understand the instruction result with reference to the copy later.

22. Interactive communication system and method using an image, wherein a video still image including characters or/and symbol drawn by the instructor is stored as hard copy so that the student can understand the instruction result with reference to the copy later.

23. Interactive communication system and method using an image according to claim 6, wherein the interactive communication means with one to several persons using moving image and voice by a network line has games including igo, chess, shogi with one to several persons.

24. Interactive communication system and method using an image according to claims 1 to 23, wherein the interactive communication means with one to several persons using the moving image and voice by a network line, further includes means for storing the moving image and voice in the receiver's PC in the case where no reception is made because a receiver is absent.

25. Interactive communication system and method using an image according to claims 1 to 24, wherein the interactive communication means with one to several persons using moving image and voice by a network line, further includes means for displaying a desired image of one to several persons displayed on the PC using a wide screen.

26. Interactive communication system and method using an image according to claims 1 to 25, wherein the interactive communication means with one to several persons using moving image and voice by a network line, displays graphics, photographs, characters such as text paper or image information, in addition to the moving image of one to several persons.

27. Interactive communication system and method using an image according to claims 1 to 26, wherein the interactive communication means with one to several persons using moving image and voice by a network line, further includes means, which is composed of substantially one examiner for employment and qualification test and one to several examinees, and displays a test question on a predetermined portion of the examinee's PC, and further, receives a test result including answers and questions from the examinee so as to take an examination from a remote place.

28. Interactive communication system and method using an image according to claims 1 to 27, wherein the interactive communication means with one to several persons using moving image and voice by a network line, further includes means, which includes substantially one interpreter displayed on other PC in interactive communication made in meeting, discussion, lecture and other languages or sign language by substantially one person.

29. Interactive communication system and method using an image according to claims 1 to 28, wherein the interactive communication means with one to several persons using moving image and voice by a network line, is capable of making transmission and reception using various mobiles such as cellular phone or the like.
